(19) United States
(12) Patent Application Publication
(10) Pub. No.: US 2015/0042011 A1
(43) Pub. Date: Feb. 12, 2015

(54) POSITIONING STRUCTURE OF THE OBJECT TO BE COATED AND ITS MANUFA CTURING METHOD

(71) Applicant: SUPREME TECHNIC PACKAGE CO., LTD., KAOHSIUNG CITY (TW)

(72) Inventor: SHENG-CHANG HUANG, KAOHSIUNG CITY (TW)

(73) Assignee: SUPREME TECHNIC PACKAGE CO., LTD., KAOHSIUNG CITY (TW)

(21) Appl. No.: 13/962,935

(22) Filed: Aug. 8, 2013

(51) Int. Cl. B05D 1/30; B05C 9/08

(52) U.S. Cl. CPC B05D 1/30; B05C 9/08
USPC 264/263; 425/110

(57) ABSTRACT

A positioning structure of an object to be coated and its manufacturing method in the present invention is first to have a supporting-positioning member with projections provided at the outer surface of the object to be coated, a restricting-positioning ring mounted at the boundary of a coating range and an induction-identification device installed within the coating range. Then, the object to be coated is positioned in the male mold of a shaping mold and an in-mold shaping label is in advance set in the female mold of the shaping mold and lastly, the male mold and the female mold are combined together and fluid thermal plastic is poured into the shaping mold. Thus, the object to be coated and the outer surface of the induction-identification device can be completely coated with a plastic layer and simultaneously, the plastic layer will be integrally formed with the in-mold shaping label.

### BACKGROUND OF THE INVENTION

1. Field of the Invention

This invention relates to a positioning structure of an object to be coated and its manufacturing method, particularly to one having the outer side of a fragile porcelain or glass product or a metal article, which is to be coated, provided with a supporting-positioning member, a restricting-positioning ring and an induction-identification device. Then the object to be coated is laid in a shaping mold and fluid thermal plastic is poured into the shaping mold to have the object to be coated, an in-mold shaping label and the induction-identification device coated with a plastic layer, thus elevating practicability of the products and enhancing their economic value.

2. Description of the Prior Art

As commonly known, temperature for shaping porcelain or glass products is very high, always over 800° C., and metal products are also produced in an environment of extremely high temperature; therefore, ink printed labels are impossible to be combined with the porcelain products, the glass products, or metal articles when they are being manufactured. Therefore, commercially available porcelain products, glass products or metal articles used as containers or utensils must have labels stuck thereon to indicate the contents in the containers, and all the labels are stuck to the porcelain products, to the glass products or to the metal articles by gluing. As a result, intentional lawbreakers have loopholes to exploit so long as they collect used or self-made porcelain products, glass products or metal articles and paste counterfeit labels thereon anew, and thus they can attain the purpose of counterfeiting. Thus, counterfeits with flaws and poor quality are apt to be confounded and circulated in the markets, but common consumers are unable to discriminate counterfeit products from genuine ones, thus likely to directly damage consumer's rights and interests as well as the goodwill of original manufacturers and even endanger consumer's health if the content is food or drink, always causing panic to consumers and also rendering the original manufacturers unable to sell their products continuously and resulting in great losses. In addition, products made of porcelain, glass or metal can hardly be installed thereon with induction-identification devices so products with high economic value are difficult in management and in prevention of burglaries.

In view of above-mentioned drawbacks, the inventor of this invention, who has accumulated much experience in designing positioning structure and manufacturing method of objects to be coated, has been dedicated to researching a technique of how to have the outer side of fragile porcelain or glass products or metal articles combined with an in-mold shaping label during a plastic layer is shaped in a mold and also have an induction-identification device integrally coated therein, thus devising this invention.

### SUMMARY OF THE INVENTION

The objective of this invention is to offer a positioning structure of an object to be coated and its manufacturing method, able to have the object to be coated formed with a protecting casing, an induction-identification device, a label and tri-dimensional decoration and applicable to fragile containers like wine bottles, chemical reagent bottles or environmental protection cups with high economical value, or pipes or parts of bicycles, motorcycles, automobiles, machines, instruments or electronic products.

The positioning structure of an object to be coated includes an object formed with an outer surface and a supporting-positioning member provided with projections. When the object to be coated is set in a shaping mold, the supporting-positioning member will let the object to be coated stably supported at a central position in the shaping mold, and the supporting space formed between the projections enables fluid thermal plastic that is poured into the shaping mold to circulate and diffuse and completely coat the outer surface of the object to be coated. A restricting-positioning ring is fixed on the outer surface of the object to be coated for restricting and stopping the shaping fluid thermal plastic in the mold and controlling a coating range of a plastic layer formed in the mold. A plastic layer formed between the outer surface of the object to be coated and an in-mold shaping label, and when being formed in the mold, the plastic layer can be formed integrally with both the object to be coated and the in-mold shaping label and also covered on an induction-identification device.

A manufacturing method of a positioning structure of an object to be coated is first to have a supporting-positioning member with projections provided on the outer surface of an object to be coated, a restricting-positioning ring fixed at the boundary of a coating range and an induction-identification device installed within the coating range. Next, the object to be coated, which is provided with the supporting-positioning member, the restricting-positioning ring and the induction-identification device, has the portion, which is not to be coated, set in the male mold of a shaping mold or in the male mold formed with a soft buffer mold sleeve, and an in-mold shaping label is in advance positioned in the female mold of the shaping mold. Lastly, the male mold is combined with the female mold, and fluid thermal plastic is poured within a coating range to form a plastic layer to completely coat the outer surface of both the object to be coated and the induction-identification device and also integrally formed and combined with the in-mold shaping label. Thus, the object to be coated can be formed with a protecting casing, an induction-identification device, a label and 3D decoration.

A manufacturing method of a positioning structure of an object to be coated is to have the object to be coated provided with a plurality of restricting-positioning rings but provided with no supporting-positioning member.

The supporting-positioning member or the restricting-positioning ring in the present invention is made of plastic or rubber with elasticity.

The supporting-positioning member in the present invention is a ring structure, a strip structure or a granular structure.

The restricting-positioning ring in the present invention is a flat ring structure, or has one end of its outer side provided with a stop circumference and another end formed into a gradually-sloping structure for matching the shape of the object to be coated, or has one end of its outer side disposed with a stop circumference and another end formed with projections.

The induction-identification device of this invention uses single frequency or multi-frequency containing ultrahigh frequency, high frequency and low frequency, or microwave radio frequency identification, magnetic strips or induction chips, and the induction-identification device can be plural sets of induction-identification devices with different functions to elevate effects of identification, anti-fake, anti-theft, induction and information reading of a coated object.

The in-mold shaping label of this invention is made of plastic, metal, paper, wood or a bamboo, or is a 3D label with 3D characters and patterns for enhancing esthetic sense and visual effect of a coated object.

### BRIEF DESCRIPTION OF DRAWINGS

This invention will be better understood by referring to the accompanying drawings, wherein:

FIG. 1 is a front view of a first preferred embodiment of a positioning structure of a bottle to be coated before being shaped in a mold in the present invention;

FIG. 2 is a schematic view of the first preferred embodiment of the positioning structure of the bottle to be coated during being shaped in a mold in the present invention;

FIG. 3 is a front view of the first preferred embodiment of the positioning structure of the bottle to be coated after being shaped in a mold in the present invention;

FIG. 4 is a perspective view of a first preferred embodiment of an annular supporting-positioning member in the present invention;

FIG. 5 is a cross-sectional view of FIG. 4;

FIG. 6 is a partial magnified view of FIG. 5;

FIG. 7A is a perspective view of a second preferred embodiment of the annular supporting-positioning member in the present invention;

FIG. 7B is a perspective view of a third preferred embodiment of the annular supporting-positioning member in the present invention;

FIG. 7C is a perspective view of a fourth preferred embodiment of the annular supporting-positioning member in the present invention;

FIG. 7D is a perspective view of a fifth preferred embodiment of the annular supporting-positioning member in the present invention;

FIG. 7E is a perspective view of a sixth preferred embodiment of the annular supporting-positioning member in the present invention;

FIG. 8A is a cross-sectional view of a first preferred embodiment of a projection of the annular supporting-positioning member in the present invention;

FIG. 8B is a cross-sectional view of a second preferred embodiment of the projection of the annular supporting-positioning member in the present invention;

FIG. 8C is a cross-sectional view of a third preferred embodiment of the projection of the annular supporting-positioning member in the present invention;

FIG. 8D is a cross-sectional view of a fourth preferred embodiment of the projection of the annular supporting-positioning member in the present invention;

FIG. 8E is a cross-sectional view of a fifth preferred embodiment of the projection of the annular supporting-positioning member in the present invention;

FIG. 8F is a cross-sectional view of a sixth embodiment preferred embodiment of the projection of the annular supporting-positioning member in the present invention;

FIG. 9A is a schematic view of a first preferred embodiment of a strip supporting-positioning member in the present invention;

FIG. 9B is a schematic view of a second preferred embodiment of the strip supporting-positioning member in the present invention;

FIG. 10A is a schematic view of a first preferred embodiment of a granular supporting-positioning member in the present invention;

FIG. 10B is a schematic view of a second preferred embodiment of the granular supporting-positioning member in the present invention;

FIG. 11 is a perspective view of a first preferred embodiment of a restricting-positioning ring in the present invention;

FIG. 12 is a cross-sectional view of the first preferred embodiment of the restricting-positioning ring in the present invention;

FIG. 13 is a cross-sectional view of a second preferred embodiment of the restricting-positioning ring in the present invention;

FIG. 14 is a perspective view of the second preferred embodiment of the restricting-positioning ring in the present invention;

FIG. 15 is a cross-sectional view of a third preferred embodiment of the restricting-positioning ring in the present invention;

FIG. 16 is a perspective view of the third preferred embodiment of the restricting-positioning ring in the present invention;

FIG. 17 is a front view of a second preferred embodiment of a positioning structure of a bottle to be coated before being shaped in a mold in the present invention;

FIG. 18 is a schematic view of the second preferred embodiment of the positioning structure of a bottle to be coated during being shaped in a mold in the present invention;

FIG. 19 is a front view of the second preferred embodiment of the positioning structure of a bottle to be coated after being shaped in a mold in the present invention;

FIG. 20 is a front view of a third preferred embodiment of the positioning structure of a bottle to be coated before being shaped in a mold in the present invention;

FIG. 21 is a schematic view of a fourth preferred embodiment of the positioning structure of a bottle to be coated during being shaped in a mold in the present invention;

FIG. 22 is a front view of a fifth preferred embodiment of the positioning structure of a bottle to be coated after being shaped in a mold in the present invention;

FIG. 23 is a front view of a sixth preferred embodiment of the positioning structure of a bottle to be coated after being shaped in a mold in the present invention;

FIG. 24 is a front view of a seventh preferred embodiment of the positioning structure of a bottle to be coated after being shaped in a mold in the present invention;

FIG. 25 is a front view of an eighth preferred embodiment of the positioning structure of a bottle to be coated before being shaped in a mold in the present invention;

FIG. 26 is a schematic view of the eighth preferred embodiment of the positioning structure of a bottle to be coated during being shaped in a mold in the present invention;

FIG. 27 is a front view of the eighth preferred embodiment of the positioning structure of a bottle to be coated after being shaped in a mold in the present invention;

FIG. 28 is a schematic view of a first preferred embodiment of a positioning structure of a glass to be coated during being shaped in a mold in the present invention;

FIG. 29 is a front view of the first preferred embodiment of the positioning structure of a glass to be coated after being shaped in a mold in the present invention;

FIG. 30 is a schematic view of a second preferred embodiment of the positioning structure of a glass to be coated during being shaped in a mold in the present invention;

FIG. 31 is a front view of a second preferred embodiment of the positioning structure of a glass to be coated after being shaped in a mold in the present invention;

FIG. 32 is a schematic view of a first preferred embodiment of a positioning structure of a pipe to be coated during being shaped in a mold in the present invention;

FIG. 33 is a front view of the first preferred embodiment of the positioning structure of a pipe to be coated after being shaped in a mold in the present invention;

FIG. 34 is a schematic view of a second preferred embodiment of the positioning structure of a pipe to be coated during being shaped in a mold in the present invention;

FIG. 35 is a front view of the second preferred embodiment of the positioning structure of a pipe to be coated after being shaped in a mold in the present invention;

FIG. 36 is a schematic view of the positioning structure of a pipe to be coated in a first using condition in the present invention; and

FIG. 37 is a schematic view of the positioning structure of a pipe to be coated in a second using condition in the present invention.

### DETAILED DESCRIPTION OF THE PREFERRED EMBODIMENT

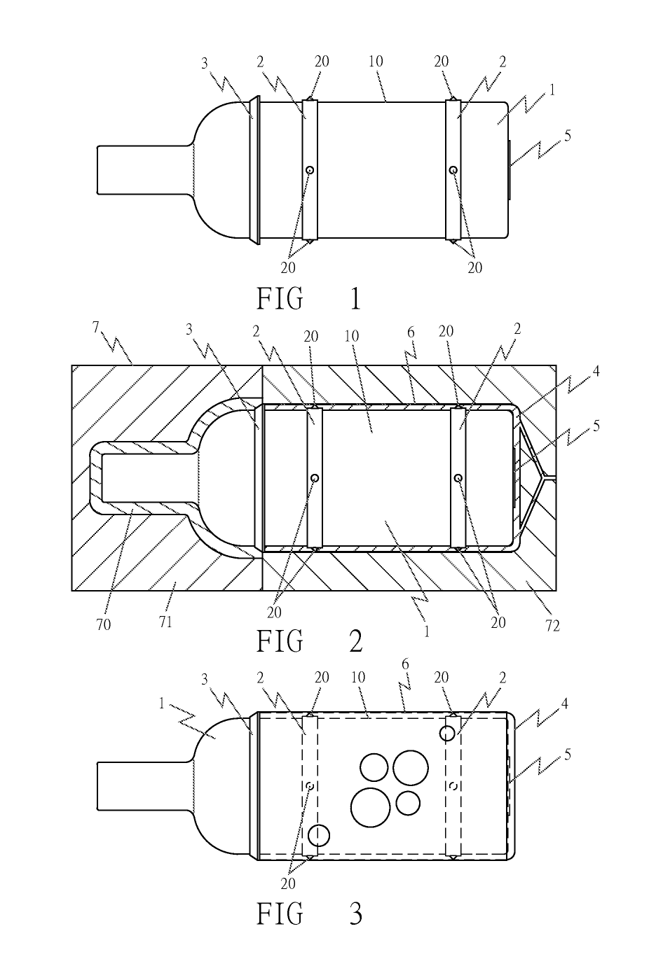

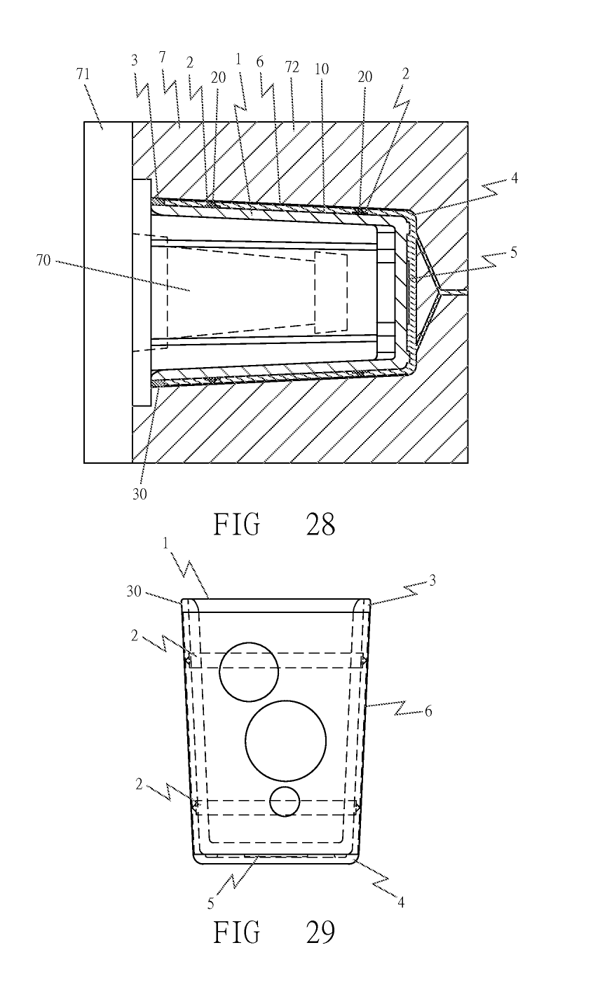

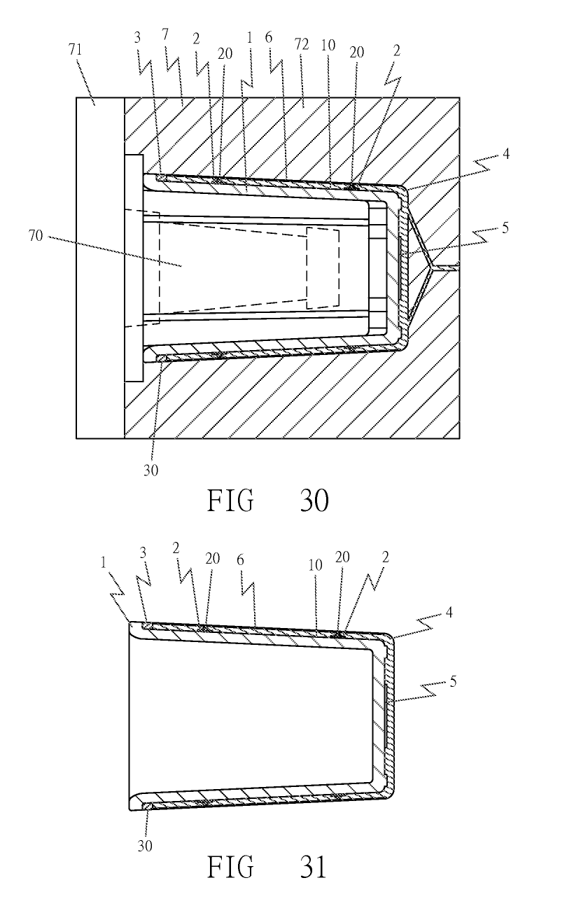

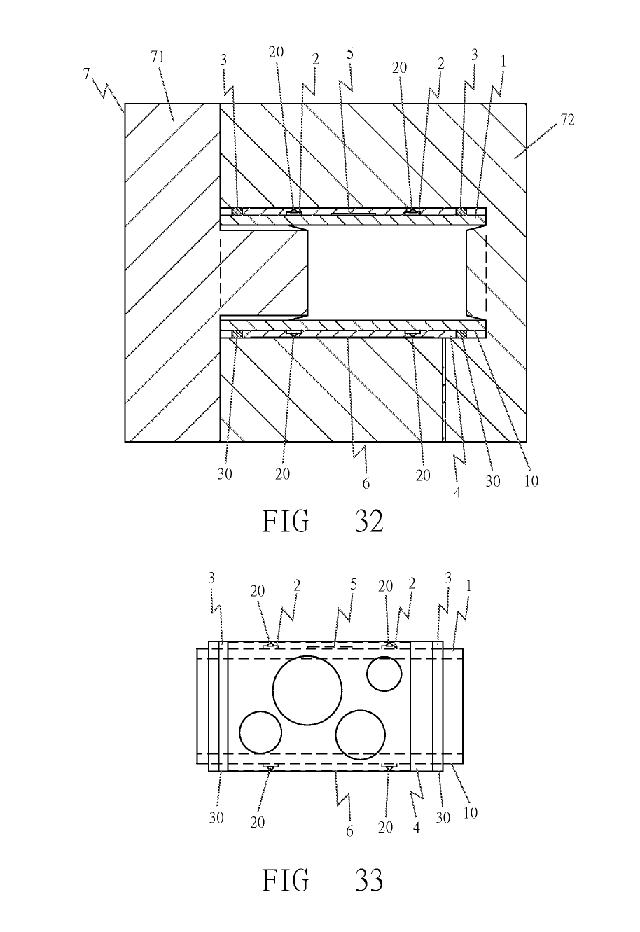

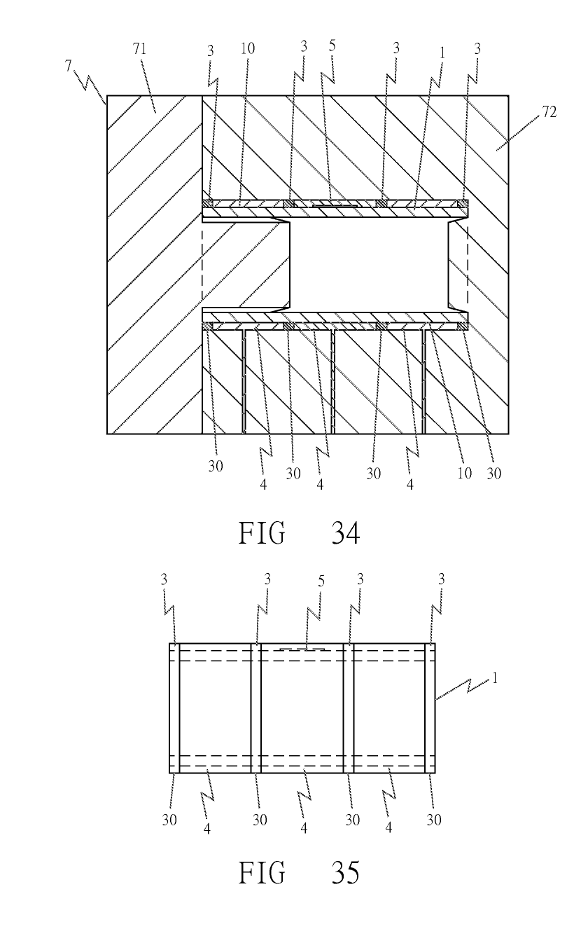

A preferred embodiment of a positioning structure of an object to be coated and its manufacturing method in the present invention, as shown in FIGS. 1-37, includes an object 1 to be coated, a supporting-positioning member 2, a restricting-positioning ring 3, a plastic layer 4, an induction-identification device 5 and an in-mold shaping label 6 as main components combined together.

The object 1 to be coated can be a bottle or a glass made of fragile material like glass or porcelain, or a container with a projecting circumference, such as a cup, a jar or a box, or a pipe or a component part, which cannot be formed integrally with an in-mold shaping label during the process of manufacture. Further, the shape of the coating portion of the object 1 to be coated can be cylindrical, of a curve column, of a gradually-sloping column, of a triangular column, of a polygonal column or of an irregular column (such as a figure molding, an animal and plant molding or other tri-dimensional designed shape), as shown in FIGS. 1, 17, 23, 24, 29 and 33. The object 1 to be coated is formed with an outer surface 10, and the supporting-positioning member 2, the restricting-positioning ring 3, the plastic layer 4, the induction-identification device 5 and the in-mold shaping label 6 are provided on the outer surface 10.

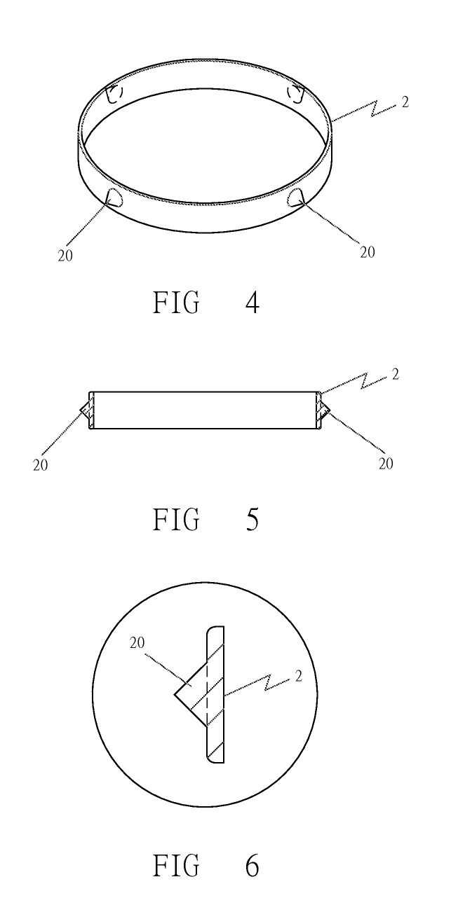

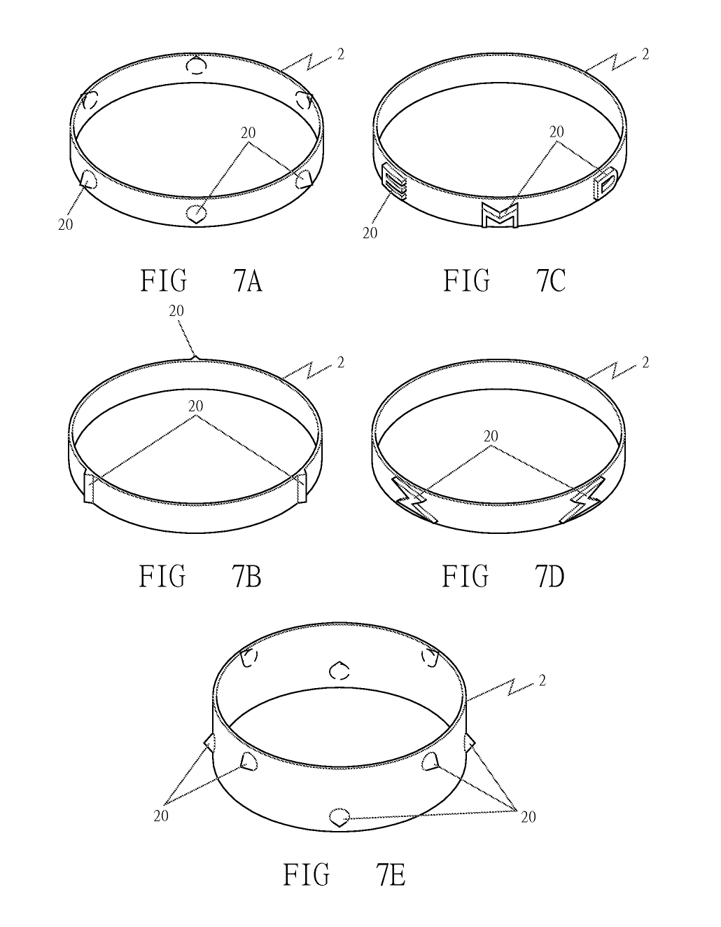

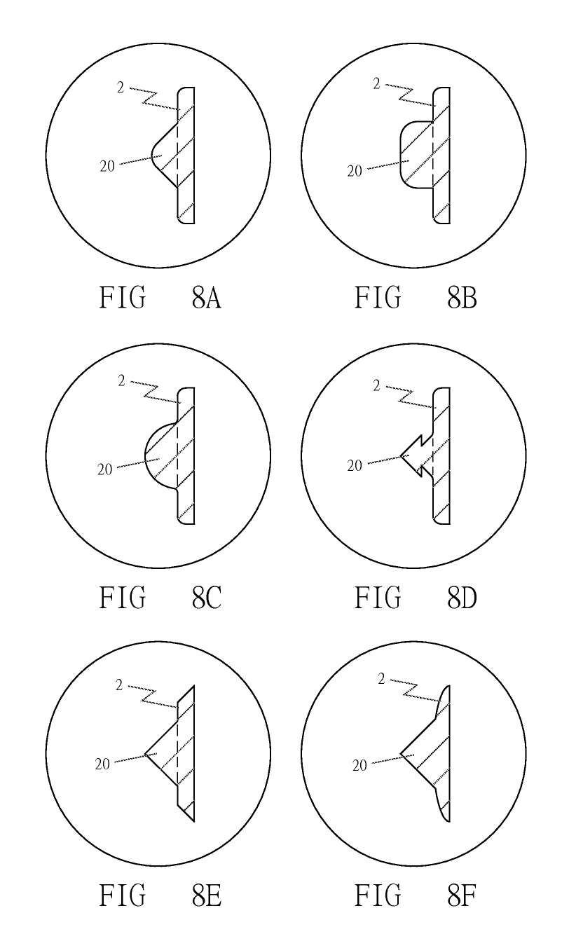

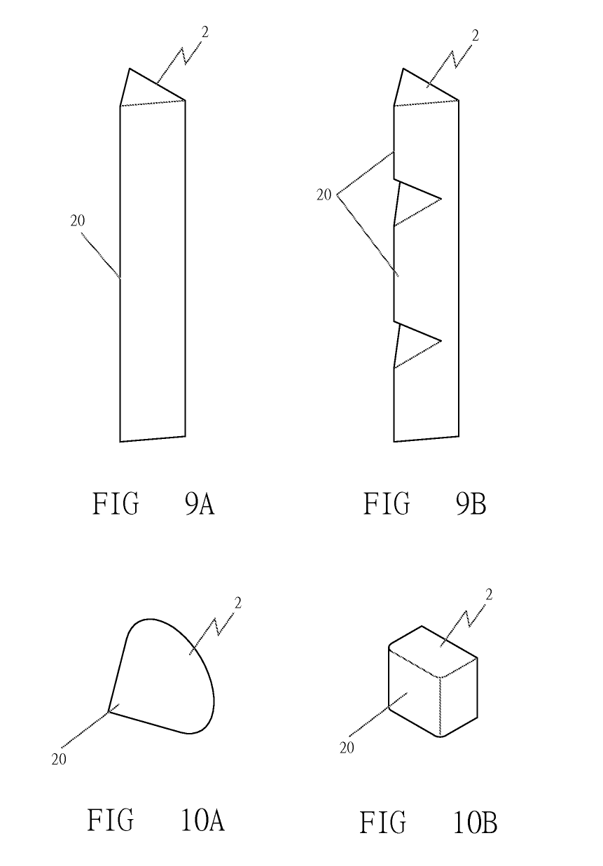

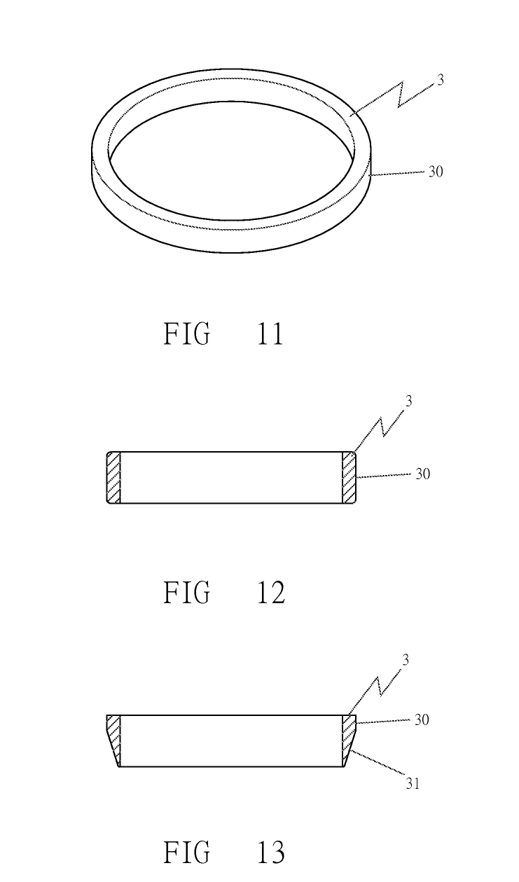

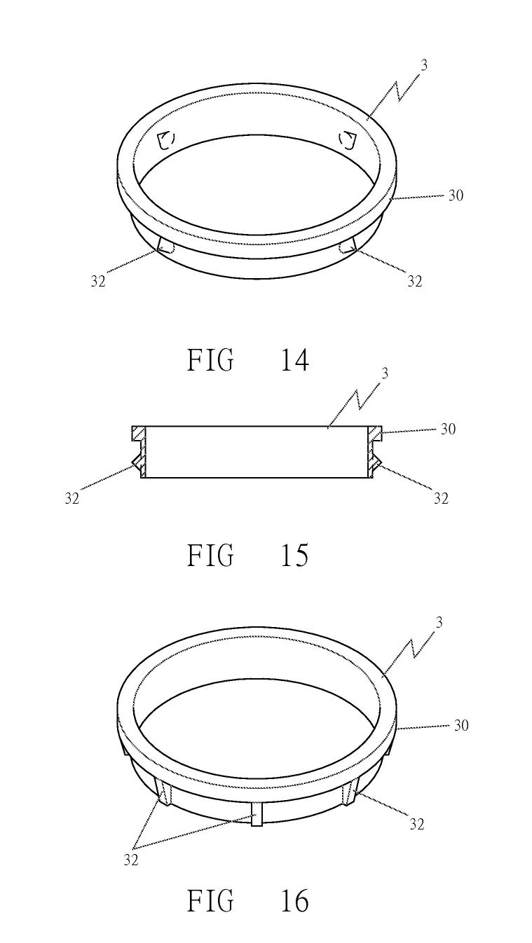

The supporting-positioning member 2 fastened on the outer surface 10 of the object 1 to be coated is made of plastic or rubber with elasticity, and the structure of the supporting-positioning member 2 can be annular, as shown in FIG. 4, bar, as shown in FIGS. 9A and 9B, or granular, as shown in FIGS. 10A and 10B. If the supporting-positioning member 2 is annular or bar, one side of the supporting-positioning member 2 is provided with a plurality of projections 20, which can be cones, triangular columns, tetragonal columns, semi-cylinders, 3D characters or 3D patterns, as shown in FIGS. 7A-7E and FIGS. 8A-8F, and the projections 20 are arranged annularly and equidistantly, as shown in FIGS. 7A-7D, or arranged in stagger, as shown in FIG. 7E. When the supporting-positioning member 2 is structured in a granular shape, the projections 20 of the granular supporting-positioning member 2 can be cones, cubes, polygonal cubes, cylinders, 3D characters or 3D patterns, and the granular supporting-positioning member 2 is to have patterns or characters provided on the outer surface 10 of the object 1 to be coated according to needs of use or design or arranged thereon randomly. The projections 20 of the supporting-positioning member 2 are employed to resist against the inner wall of a mold when the object 1 to be coated is deposited in a shaping mold 7, and the elasticity of the projections 20 can function to solve the problem of inconsistency in size of an object to be coated caused by tolerance during manufacturing course and also let the object 1 to be coated stabilized and supported at the central location in the shaping mold 7 to prevent the object 1 to be coated from moving bias and affecting plastic molding operation in the mold. Further, the supporting spaces formed between the plural projections 20 enable fluid thermal plastic of injection molding, extrusion molding, blow molding or hollow molding to circulate and diffuse and completely coat the outer surface 10 of the object 1 to be coated to form a plastic layer 4, and during the shaping course, the plastic layer 4 will be formed integrally with the in-mold shaping label 6. When the object 1 to be coated is removed from the shaping mold 7 after shaped, the supporting-positioning member 2 or its projections 20 will no longer be pressed by the inner wall of the mold and will retrieve elasticity and recover their original thickness to have the outermost layer of the coated object 1 forming projecting decoration for elevating external beauty and marking of the coated object and attaining tri-dimensional visual effect.

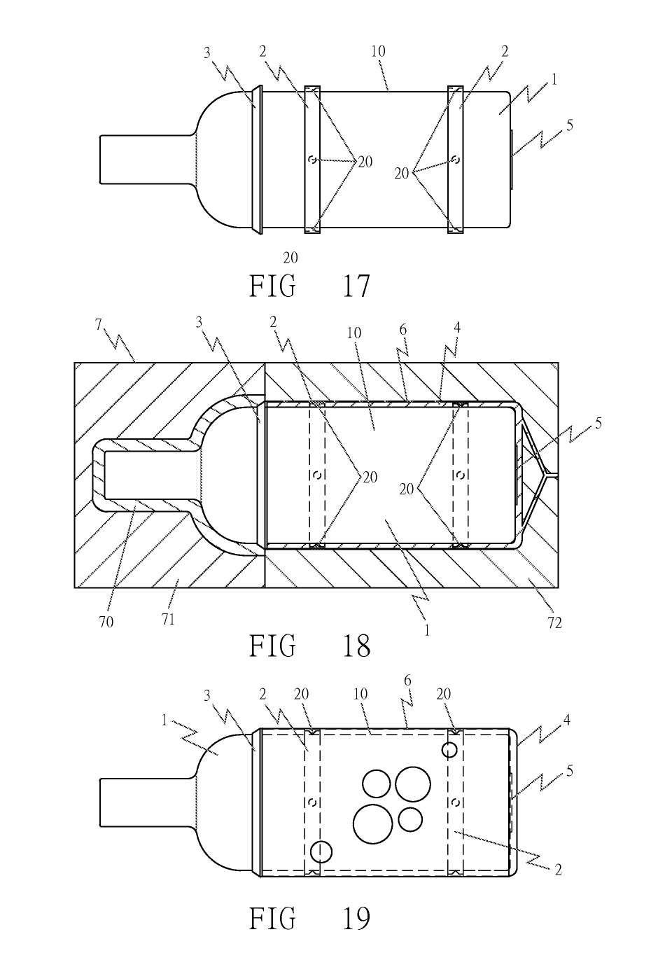

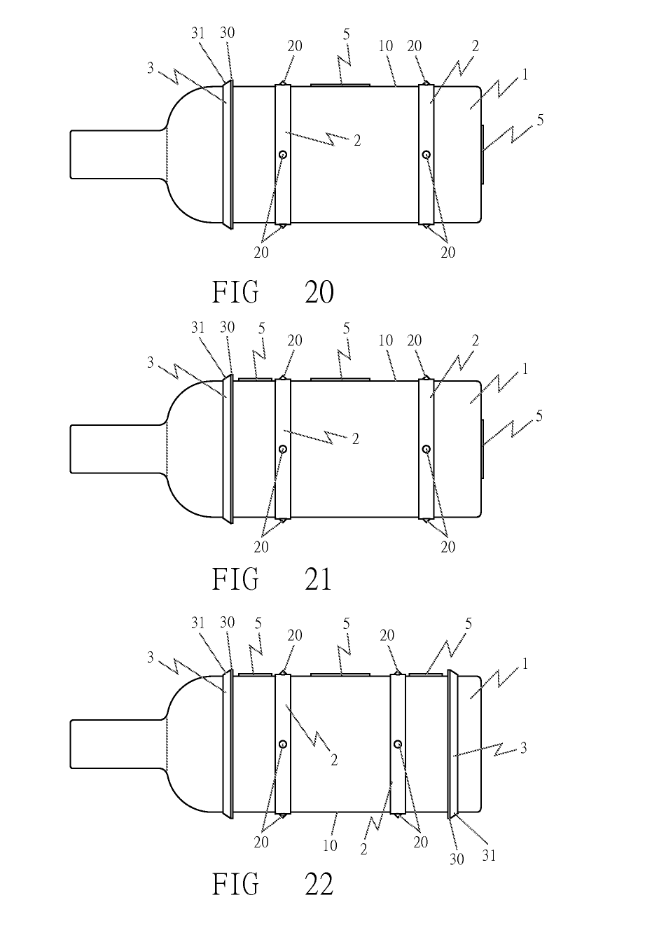

The restricting-positioning ring 3 is mounted on the outer surface 10 of the object 1 to be coated for restricting and stopping shaping fluid thermal plastic in the mold and controlling a coating range of the plastic layer 4 shaped in the mold. The restricting-positioning ring 3 can be of a common ring structure, as shown in FIG. 11, or has one end of its outer side provided with a stop annular circumference 30 and another end formed into a gradually-sloping structure 31 for matching the shape of the object 1 to be coated, as shown in FIG. 31, to avoid producing an uncoordinated feel between the boundary of coating substance and the object 1 to be coated and attain a visual effect of integrity of the coating substance and the object 1 to be coated, as shown in FIGS. 3, 19 and 27. Or one end of the outer side of the restricting-positioning ring 3 is provided with a stop circumference 30 and another end disposed with equidistant projections 32, as shown in FIGS. 14 and 16. The projections 32 can be cones, tetragonal columns, semi-cylinders, 3D characters or 3D patterns. The stop circumference 30 functions to restrict and stop shaping fluid thermal plastic in mold. If the projections 31 are provided at one end of the object to be coated and the coated object 1 is removed from the mold, the restricting-positioning ring 3 or the projections 31 are no longer pressed by the inner wall of the mold and will retrieve their elasticity and recover their original thickness to have the outermost layer of the coated object 1 forming projecting 3-D decoration. If the projection 31 is disposed at another end of the object 1 coated with the plastic layer 4, the projection 31 can directly serve as 3-D direction, thus enhancing external beauty and marking of the coated object and achieving 3-D visual effect.

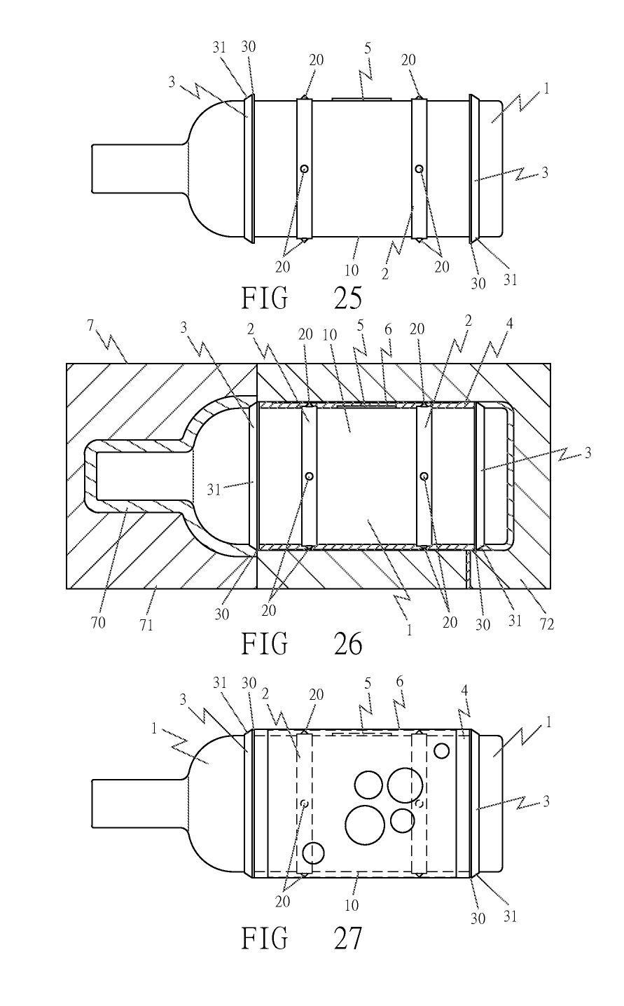

The induction-identification device 5 is installed on the outer surface 10 of the object 1 to be coated. After the plastic layer 4 is formed, the induction-identification device 5 will be coated at the inner side of the in-mold shaping label 6 and the plastic layer 4 to be protected and concealed by both the in-mold shaping label 6 and the plastic layer 4 and thus, burglars cannot directly destroy or remove the induction-identification device 5 from a coated object and steal the coated object. The induction-identification device 5 can use single frequency or multi-frequency containing ultrahigh frequency, high frequency and low frequency, or radio frequency identification (RFID) of microwave, magnetic strip or induction chips, and the induction-identification device 5 can be provided with a plurality of sets of induction-identification devices, as shown in FIGS. 20-22, for elevating effects of identification, anti-fake, anti-theft, induction and information reading.

The in-mold shaping label 6 is a label structure that can be formed integrally with the plastic layer 4 in a plastic shaping process in a mold. The in-mold shaping label 6 can be made of plastic, metal, paper, wood or bamboo or can be a 3D label with 3D characters or patterns, depending on needs for enhancing esthetic sense and visual effect of the coated object and increasing economic value of the coated object.

A first preferred embodiment of a manufacturing method of an object to be coated in the present invention, as shown in FIGS. 1-3 and 17-33, is applicable to an object 1 made of fragile material like glass or porcelain, such as a bottle, a glass or a container formed with a projecting circumference like a cup, a jar or a box. The manufacturing method in this preferred embodiment is first to have one or plural supporting-positioning members 2 provided in advance at the outer surface 10 within a coating range of an object 1 to be coated, and have a restricting-positioning ring 3 mounted at the boundary of the coating range and one or plural induction-identification device 5 installed within the coating range, as shown in FIGS. 20-22, 28, 32. Next, the object 1 to be coated has a portion, which is not to be coated, set in a male mold 71 or a male mold with a soft buffer mold sleeve 70 of a shaping mold 7 (made in advance in accordance with the external form of the object to be coated) and then an in-mold shaping label 6 is set beforehand in a female mold 72 of the shaping mold 7. When the male mold 71 and the female mold 72 are combined together, the projections 20 of the supporting-positioning member 2 and the restricting-positioning ring 3 will be pushed, pressed and corrected by the inner wall of the female mold 72, able to insure the object 1 to be coated precisely positioned in the center of the female mold 72. At this time, fluid thermal plastic is fed into the shaping mold 7 for carrying out injection molding, extrusion molding, blow molding or hollow molding within a coating range, and by the supporting space of the supporting-positioning member 2 or between the projections 20 of the supporting-positioning member 2, the fluid thermal plastic can circulate and diffuse to completely coat the outer surface 10 of the object 1. After shaped, the plastic layer 4 will be formed integrally with the in-molding shaping label 6 and have induction-identification device 5 coated therein. Thus, the object to be coated can be formed with a protecting casing, an induction-identification device, a label and 3D decoration.

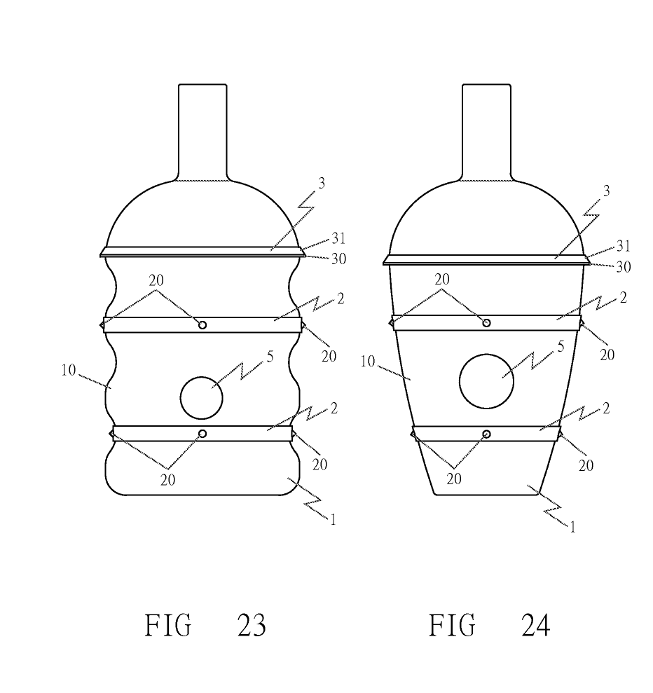

If it is needless to have the projections 20 of the supporting-positioning member 2 forming 3-D decoration, the projections 20 of the supporting-positioning member 2 can be provided on the outer surface 10 of the object 1 to be coated, as shown in FIGS. 17-19.

If the object 1 to be coated has only a partial range needed to be coated, plural restricting-positioning rings 3 can be mounted at the boundaries of the coating range of the object 1 to be coated and then the plastic layer 4 is formed within the range to be coated, as shown in formed within the range to be coated, as shown in FIGS. 25-27 and FIGS. 32-33.

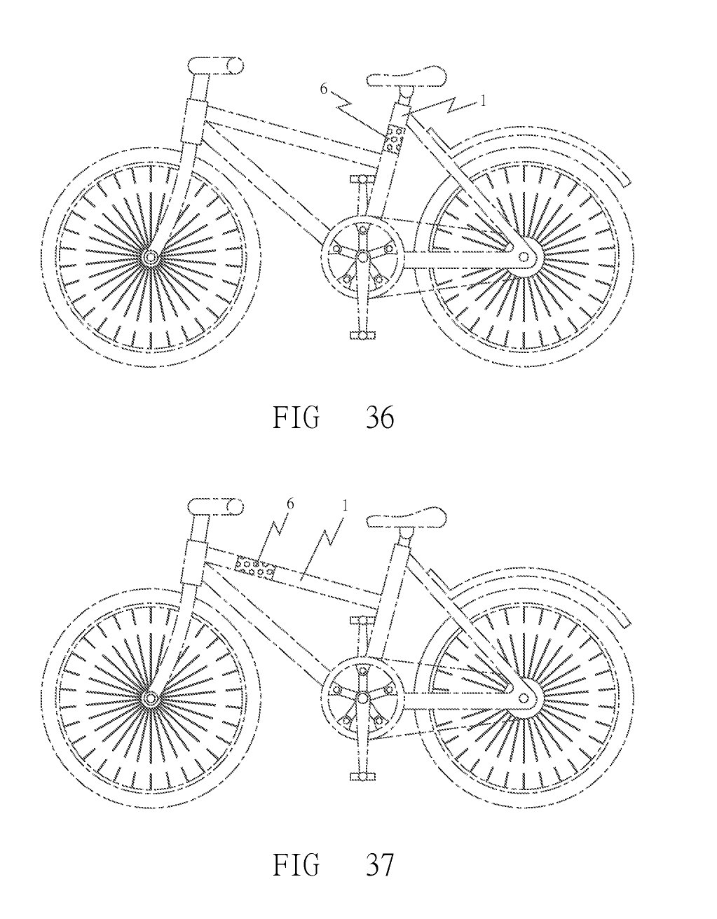

A second preferred embodiment of the manufacturing method of the position structure of an object to be coated in the present invention, as shown in FIGS. 34 and 35, is applicable to pipes or component parts, which are made of metal. The manufacturing method of this preferred embodiment is first to have a plurality of restricting-positioning rings 3 in advance fixed at the boundaries of a coating range of the outer surface 10 of the object 1 to be coated and then have one or plural induction-identification device 5 installed within the coating range, as shown in FIGS. 20-22 and FIGS. 28 and 32. Then, the object 1 to be coated is positioned in the male mold 71 of a shaping mold 7, and an in-mold shaping label 6 is in advance provided (or not provided) in the female mold 72 of the shaping mold 7. When the male mold 71 and the female mold 72 are combined together, the restricting-positioning ring 3 and the inner wall of the female mold 72 will be mutually pushed, pressed and corrected, able to insure the object 1 to be coated to be precisely set at the central position of the female mold 72. At this time, fluid thermal plastic can be fed within the coating range via injection molding, extrusion molding, blow molding or hollow molding to have the fluid thermal plastic circulate and diffuse and completely coating the outer surface 10 of the object 1 to be coated, and after formed, the plastic layer 4 will be integrally formed with the in-mold shaping label 6 and coat the induction-identification device 5 therein. Thus, the coated object 1 can be formed with a protecting casing, an induction-identification device, a label and 3D decoration.

Therefore, the positioning structure of an object to be coated and its manufacturing method can be applied to fragile containers like wine bottles, chemical reagent bottles or environmental protection cups with high economic value, or pipes or parts of bicycles, motorcycles, automobiles, machines, instruments or electronic products, letting the coated objects formed with a protecting casing, an induction-identification device, a label and 3D decoration. When a coated object is a fragile container, the protecting casing formed on the outer surface of the container can produce effects of buffer and protection in case of collision; therefore, when the container is broken carelessly, the protecting casing can function to temporarily support the bottle structure to stop liquid and splinters of the container from scattering about and splashing or cutting other people. In addition, the induction-identification device, the label and the 3-D decoration can produce marked effects of identification, anti-counterfeit, anti-theft, induction, information reading, decoration and esthetic sense, able to elevate practicability and economic value of a coated object.

While the preferred embodiments of the invention have been described above, it will be recognized and understood that various modifications may be made therein and the appended claims are intended to cover all such modifications that may fall within the spirit and scope of the invention.

1. A positioning structure of an object to be coated comprising:
an object to be coated, said object to be coated formed with an outer surface;
a supporting-positioning member provided on said outer surface of said object to be coated, said supporting-positioning member disposed with projections, said projections of said supporting-positioning member pushing against inner walls of a mold when said object to be coated is set in a shaping mold, said supporting-positioning member with elasticity able to adjust said object to be coated to be stably supported at a central position in the mold, supporting spaces formed between said projections enabling fluid thermal plastic that is poured into said shaping mold to circulate and diffuse and completely coat said outer surface of said object to be coated;
a restricting-positioning ring mounted on said outer surface of said object to be coated for restricting and stopping said fluid thermal plastic to be shaped in the mold and for controlling a coating range of a plastic layer formed in said shaping mold;
a plastic layer formed between said outer surface of said object to be coated and an in-mold shaping label, said plastic layer formed integrally with both said object to be coated and said in-mold shaping label when said plastic layer is being shaped in said shaping mold;
an induction-identification device installed on said outer surface of said object to be coated, said induction-identification device coated between said object to be coated and said plastic layer; and
said in-mold shaping label being a label structure able to be formed integrally with said plastic layer in a plastic molding process in the mold;

2. A positioning structure of an object to be coated comprising:
an object to be coated, said object to be coated formed with an outer surface;
a restricting-positioning ring mounted on said outer surface of said object to be coated for restricting and blocking fluid thermal plastic to be shaped in a mold to control a coating range of a plastic layer to be formed in mold;
a plastic layer formed between said outer surface of said object to be coated and an in-mold shaping label, said plastic layer able to be formed integrally with both said object to be coated and said in-mold shaping label when said plastic layer is being formed in a mold;
an induction-identification device installed on said outer surface of said object to be coated, said induction-identification device coated between said object to be coated and said plastic layer; and
said in-mold shaping label being a label structure able to be formed integrally with said plastic layer in a plastic molding process in a mold.

3. The positioning structure of an object to be coated as claimed in claim 1, wherein said object to be coated is a bottle or a cup made of glass, porcelain, fragile material or metal, or said object to be coated is a container with a projecting circumference, such as a cup, a jar or a box, or is a pipe, a component part or an article impossible to be formed integrally with an in-mold shaping label during a manufacturing process.

4. The positioning structure of an object to be coated as claimed in claim 1, wherein the shape of a coating portion of said object to be coated is cylindrical, of a curve column, of a gradually-sloping column, of a triangular column, of a polygonal column or an irregular column.

5. The positioning structure of an object to be coated as claimed in claim 1, wherein said supporting-positioning member and said restricting-positioning ring are respectively plural ones.

6. The positioning structure of an object to be coated as claimed in claim 1, wherein said supporting-positioning member and said restricting-positioning ring are made of elastic plastic or rubber.

7. The positioning structure of an object to be coated as claimed in claim 1, wherein said supporting-positioning member is a ring structure or a strip structure having one side provided with a plurality of projections, said projections of said ring or strip supporting-positioning member being cones, triangular columns, tetragonal columns, semi-cylinder, tri-dimensional characters or tri-dimensional patterns.

8. The positioning structure of an object to be coated as claimed in claim 1, wherein said supporting-positioning member is annular or strip-shaped, and said annular or strip-shaped supporting-positioning member has one side provided with a plurality of projections, said projections of said ring-shaped or strip-shaped supporting-positioning member arranged annularly or arranged in stagger.

9. The positioning structure of an object to be coated as claimed in claim 1, wherein said supporting-positioning member is granular, and said projections of said granular supporting-positioning member are cones, cubes, polygonal cubes, cylinders, tri-dimensional characters or tri-dimensional patterns.

10. The positioning structure of an object to be coated as claimed in claim 1, wherein said supporting-positioning member is granular, and said granular supporting-positioning members can be arranged on said outer surface of said object to be coated in a figure shape, a character shape or randomly disposed form in accordance with needs or design.

11. The positioning structure of an object to be coated as claimed in claim 1, wherein said restricting-positioning ring has one end of an outer side provided with a stop circumference and another end formed with a gradually-sloping structure for matching the shape of said object to be coated to let a portion between the boundary of said restricting-positioning ring and said object to be coated not produce uncoordinated feel but produce a visual effect of integrity.

12. The positioning structure of an object to be coated as claimed in claim 1, wherein said supporting-positioning ring has one end of the outer side formed with a stop circumference and another end disposed with projections, said stop circumference functioning to restrict and block fluid thermal plastic in mold, said projections producing an effect of 3-D decoration.

13. The positioning structure of an object to be coated as claimed in claim 1, wherein said supporting-positioning ring has one end of the outer side provided with a stop circumference for restricting and stopping fluid thermal plastic shaped in a mold and another end disposed with projections, said projections being cones, triangular columns, tetragonal columns, semi-cylinders, 3-D characters or 3-D patterns for producing a 3-D decorative effect.

14. The positioning structure of an object to be coated as claimed in claim 1, wherein said induction-identification device uses single frequency or multi-frequency containing ultrahigh frequency, high frequency and low frequency, or micro-wave radio frequency identification, magnetic strips or induction chips.

15. The positioning structure of an object to be coated as claimed in claim 1, wherein said induction-identification device is single frequency or multi-frequency containing ultrahigh frequency, high frequency and low frequency, or micro-wave radio frequency identification, magnetic strips or induction chips, said induction-identification device can be provided with plural sets of induction-identification devices for elevating efficacies of identification, anti-counterfeit, anti-theft, induction and information reading.

16. The positioning structure of an object to be coated as claimed in claim 1, wherein said in-mold shaping label is made of plastic, metal, paper, wood or bamboo, or said in-mold shaping label is a tri-dimensional label with 3-D characters or patterns.

17. A manufacturing method of the positioning structure of an object to be coated comprising following steps:
Step one: a supporting-positioning member with projections provided on an outer surface of an object to be coated, and a restricting-positioning ring fixed at a borderline of a coating range;
Step two: an induction-identification device installed within a coating range;
Step three: having said object to be coated, which is provided with said supporting-positioning member and said restricting-positioning ring and said induction-identification device, set in a male mold of a shaping mold;
Step four: an in-mold shaping label in advance provided in a female mold of said shaping mold;
Step five: said male mold and said female mold combined together, said projections of said supporting-positioning member together with said restricting-positioning ring and an inner wall of said female mold mutually pushed, pressed and corrected to insure said object to be coated to be precisely set in a central position of said female mold; and
Step six: fluid thermal plastic poured within said coating range to let a plastic layer completely coated on the outer surface of both said object to be coated and said induction-identification device and integrally formed with said in-mold shaping label, said object to be coated able to be formed with a projecting casing, an induction-identification device, a label and tri-dimensional decoration.

18. A manufacturing method of the positioning structure of an object to be coated comprising the following steps:
Step one: a restricting-positioning ring beforehand fixed at a boundary of a coating range of an outer surface of an object to be coated;
Step two: an induction-identification device installed within said coating range;
Step three: having said object to be coated, which is provided with said restricting-positioning ring and said induction-identification device, laid in a male mold of a shaping mold;
Step four: an in-mold shaping label in advance set in a female mold of said shaping mold;
Step five: said male mold combined with said female mold, said restricting-positioning ring and an inner wall of said female mold mutually pushed, pressed and corrected to enable said object to be coated to be precisely positioned at a central location of said female mold; and
Step six: fluid thermal plastic poured within said coating range to form a plastic layer, said plastic layer completely coated on an outer surface of both said object to be coated and said induction-identification device and integrally combined with said in-mold shaping label, said object to be coated able to be formed with a projecting casing, an induction-identification device, a label and 3D decoration.

19. The manufacturing method of the positioning structure of an object to be coated as claimed in claim 17, wherein a soft buffer mold sleeve is in advance provided in said male mold of said shaping mold.

20. The positioning structure of an object to be coated as claimed in claim 2, wherein said object to be coated is a bottle or a cup made of glass, porcelain, fragile material or metal, or said object to be coated is a container with a projecting circumference, such as a cup, a jar or a box, or is a pipe, a component part or an article impossible to be formed integrally with an in-mold shaping label during a manufacturing process.

21. The positioning structure of an object to be coated as claimed in claim 2, wherein the shape of a coating portion of said object to be coated is cylindrical, of a curve column, of a gradually-sloping column, of a triangular column, of a polygonal column or an irregular column.

22. The positioning structure of an object to be coated as claimed in claim 2, wherein said supporting-positioning member and said restricting-positioning ring are respectively plural ones.

23. The positioning structure of an object to be coated as claimed in claim 2, wherein said supporting-positioning member and said restricting-positioning ring are made of elastic plastic or rubber.

24. The positioning structure of an object to be coated as claimed in claim 2, wherein said restricting-positioning ring has one end of an outer side provided with a stop circumference and another end formed with a gradually-sloping structure for matching the shape of said object to be coated to let a portion between the boundary of said restricting-positioning ring and said object to be coated not produce uncoordinated feel but produce a visual effect of integrity.

25. The positioning structure of an object to be coated as claimed in claim 2, wherein said supporting-positioning ring has one end of the outer side formed with a stop circumference and another end disposed with projections, said stop circumference functioning to restrict and block fluid thermal plastic in mold, said projections producing an effect of 3-D decoration.

26. The positioning structure of an object to be coated as claimed in claim 2, wherein said supporting-positioning ring has one end of the outer side provided with a stop circumference for restricting and stopping fluid thermal plastic shaped in a mold and another end disposed with projections, said projections being cones, triangular columns, tetragonal columns, semi-cylinders, 3-D characters or 3-D patterns for producing a 3-D decorative effect.

27. The positioning structure of an object to be coated as claimed in claim 2, wherein said induction-identification device uses single frequency or multi-frequency containing ultrahigh frequency, high frequency and low frequency, or micro-wave radio frequency identification, magnetic strips or induction chips.

28. The positioning structure of an object to be coated as claimed in claim 2, wherein said induction-identification device is single frequency or multi-frequency containing ultrahigh frequency, high frequency and low frequency, or micro-wave radio frequency identification, magnetic strips or induction chips, said induction-identification device can be provided with plural sets of induction-identification devices for elevating efficacies of identification, anti-counterfeit, anti-theft, induction and information reading.

29. The positioning structure of an object to be coated as claimed in claim 2, wherein said in-mold shaping label is made of plastic, metal, paper, wood or bamboo, or said in-mold shaping label is a tri-dimensional label with 3-D characters or patterns.

30. The manufacturing method of the positioning structure of an object to be coated as claimed in claim 18, wherein a soft buffer mold sleeve is in advance provided in said male mold of said shaping mold.
